(19) United States
(12) Patent Application Publication
(10) Pub. No.: US 2001/0034612 A1
(43) Pub. Date: Oct. 25, 2001

(54) Transportation system, transportation method, mandatory terminal of transportation vehicle, ordering terminal and order receiving server

(76) Inventors: Takahiro Hayashi, Tokyo (JP); Akinari Ito, Tokyo (JP)

Correspondence Address: SUGHRUE, MION, ZINN, MCPEAK & SEAS, 2100 Pennsylvania Avenue, N.W., Washington, DC, 20037, US

(21) Appl. No.: 09/838,341

(22) Filed: Apr. 20, 2001

(30) Foreign Application Priority Data
Apr. 21, 2000 (JP) 121500/2000

(51) Int. Cl. G06F 17/60

(52) U.S. Cl. 705/1; 705/6

(57) ABSTRACT

In the transportation system, an order receiving terminal receives current location information from mandatory terminals of a plurality of transportation vehicles to specify current location information of the plurality of transportation vehicles, receives delivery information including a location of a business connection in charge of a customer's object to be transported and a location of a delivery destination from a plurality of ordering terminals to specify a location of the business connection in charge of the customer's object to be transported and a location of the delivery destination, specifies a transportation vehicle having current location information of a transportation vehicle closest to the location of the business connection in charge of the customer's object to be transported among current location information of the plurality of transportation vehicles as a mandatory transportation vehicle, and transmits delivery information including the location of the business connection in charge of the customer's object to be transported and the location of the delivery destination to a mandatory terminal of the transportation vehicle specified as the mandatory transportation vehicle.

### BACKGROUND OF THE INVENTION

1. Field of the Invention

The present invention relates to a transportation system, a transportation method, a mandatory terminal of a transportation vehicle, an ordering terminal and an order receiving server.

2. Description of the Related Art

In general, transportation companies provide the service of transporting an object from one place to another according to a customer's request as business. Among transportation companies here are, for example, door-to-door trucking service companies and house-moving companies.

Door-to-door trucking service companies deliver objects from one place (house) to another (house) according to a customer's request, while house-moving companies transport objects (property to be moved) from one place (former house) to another (new house) according to a customer's request. More specifically, a customer specifies a transportation company based on attributes of objects whose transportation is demanded (hereinafter referred to as “object to be transported”) and then orders transportation of the objects, while the specified transportation company (door-to-door trucking service company, house-moving company etc.) accepts an order for transporting the objects from the customer and transports the same.

In addition to substantive nature of an object (size, weight, handle with care or not, etc.), attributes of objects to be transported also include nature in usage of an object (for house-moving, for gifts, urgent transportation or not, very urgent transportation or not, etc.). In a case where an attribute of an object to be transported is transportation with urgency, that is, when a customer wants the object to be transported quickly, therefore, the customer will specify a transportation company capable of transporting the object to be transported by, for example, the next day.

Responsively, a transportation company capable of transporting an object to be transported by the next day sets a collection route by grouping each business connection (one place) for each of a plurality of customers in the order of closeness and sequentially collects objects to be transported at each business connection (one place) on the collection route by means of a vehicle (truck etc.) Then, the transportation company sets a delivery route by grouping each delivery destination (other place) of each of the plurality of collected objects to be transported in the order of closeness and sequentially delivers the objects to be transported to each delivery destination (other place) on the delivery route by means of a vehicle (truck).

In other words, the transportation company capable of transporting an object to be transported by the next day transports an object from one place to another through a collection route and a delivery route according to a customer's request.

On the other hand, when an attribute of an object to be transported is transportation with great urgency, that is, when a customer wants an object to be transported more quickly, the customer will specify a transportation company which is capable of transporting an object on the day when transportation of an object is ordered or within several hours from the time when an order is placed.

The transportation company capable of transporting an object to be transported on the day when transportation of an object is ordered or within several hours from the time when an order is placed responsively collects the object to be transported at a business connection (one place) for one customer by means of a vehicle (light four-wheeled car, motorcycle, two-wheeled vehicle, etc.) or an attendant. Then, the transportation company deliveries the object to be transported to a delivery destination (other place) for the one customer by means of a vehicle etc.

In other words, the transportation company capable of transporting an object to be transported on the day when transportation of an object is ordered or within several hours from the time when an order is placed directly transports the object from one place to another according to a customer's request.

In a case where an attribute of an object to be transported is transportation with great urgency, that is, when a customer wants the object to be transported more quickly, such problems as follows occur.

A vehicle of a transportation company for directly transporting an object from one place to another according to a customer's request transports an object to be transported with the transportation company as a starting point and an end point. More specifically, a customer orders transportation of an object from a specified transportation company by telephone, while the transportation company receiving the order for transportation of the object from the customer informs a vehicle waiting in a lot of the transportation company about a business connection (one place). Responsively, the vehicle waiting in the lot accepts a mandate for transportation of the object to be transported and goes to the business connection (one place) with the transportation company as a starting point to receive the object to be transported from the customer. Next, the vehicle directly goes to a delivery destination (other place) to hand the object to be transported over to a recipient that the customer designates. Here, although the vehicle substantially completes transportation of the object to be transported, it returns to the lot of the transportation company to again wait for receiving a mandate for transportation of a new object to be transported.

Accordingly, while when a business connection (one place) and a transportation company are close to each other, time will be short which is cost by a vehicle to go to the business connection with the transportation company as a starting point, when the business connection and the transportation company are away from each other, time will be long which is cost by a vehicle to go to the business connection with the transportation company as a starting point. In other words, since a time is required for the vehicle to go to the business connection (one place) with the transportation company as a starting point, the transportation company can not always transport an object quickly according to a customer's request.

In addition, in a case where a customer (Mr. A of an A company) orders transportation of an object (product handled by Mr. A) at an ordinary business connection (in the A company), the customer (Mr. A of the A company) is allowed to specify an ordinary transportation company (A transportation company) and make a call. On the other hand, in a case where the customer (Mr. A of the A company) orders transportation of an object (product handled by Mr. A) at a business connection (B company with which business is done) different from an ordinary one, it is desirable that the customer (Mr. A of the A company) specifies a transportation company (B transportation company) near from the business connection (B company with which business is done) different from an ordinary one and makes a call.

However, since the customer (Mr. A of the A company) is at a business connection different from an ordinary one, it will take a time for specifying a transportation company (B transportation company) near from the business connection (B company with which business is done) different from an ordinary one. Or in a case where the customer (Mr. A of the A company) can not specify the transportation company (B transportation company) near from the business connection (B company with which business is done) different from an ordinary one, the customer (Mr. A of the A company) will place an order for transportation of an object with the ordinary transportation company (A transportation company). When it takes a time for the customer to specify a transportation company or when the business connection (B company with which business is done) different from an ordinary one and the ordinary transportation company (A transportation company) are away from each other, the transportation company can not always transport an object quickly according to a customer's request.

When a customer is at a place (unfamiliar place) different from an ordinary one, there accordingly occurs a problem that the customer can not specify with ease a transportation company (transportation company close to a business connection) capable of transporting an object quickly from one place to another.

### SUMMARY OF THE INVENTION

The present invention is realized in consideration of the problems under the foregoing conditions and has an object of providing a transportation system, a transportation method, a mandatory terminal of a transportation vehicle, an ordering terminal and an order receiving server which enable quick transportation of objects according to a customer's request and enable a customer to specify a transportation company with ease.

According to the first aspect of the invention, a transportation system comprises

mandatory terminals of a plurality of transportation vehicles which directly transport an object to be transported from a business connection to a delivery destination for periodically transmitting current location information of their own to an order receiving server through a line to receive delivery information including a location of a business connection in charge of an object to be transported and a location of a delivery destination from the order receiving server through the line,

a plurality of ordering terminals for placing an order for transportation of an object to be transported which transmit order information including a location of a business connection in charge of the object to be transported and a location of a delivery destination to the order receiving server through the line, and

an order receiving order for receiving an order for transportation of the object to be transported which transmits, for each the order information, the delivery information to specific the transportation vehicle closest to a location of a business connection in charge of the object to be transported among the transportation vehicles.

In the preferred construction, the mandatory terminal of the transportation vehicle includes

transmission means for periodically transmitting current location information of its own to the order receiving server through the line, and

means for receiving delivery information including a location of a business connection in charge of the object to be transported and a location of a delivery destination from the order receiving server through the line, and

the order receiving server includes:

means for receiving the current location information of one's own from each the mandatory terminal of the plurality of transportation vehicles through the line to specify each current location information of the plurality of transportation vehicles,

means for receiving the order information from each of the plurality of ordering terminals through the line to specify each location of a business connection in charge of the object to be transported and each location of a delivery destination,

means for specifying a transportation vehicle having the current location information of a transportation vehicle closest to each location of a business connection in charge of the object to be transported among respective current location information of the plurality of transportation vehicles as a mandated transportation vehicle, and

means for transmitting the delivery information to each mandatory terminal of the transportation vehicle specified as the mandated transportation vehicle through the line.

Therefore, according to a transportation system of a first invention of the present application, mandatory terminals of a plurality of transportation vehicles are allowed to transmit current location information of their own to an order receiving server in a desired period. Here, a desired period represents a period where a driver of a transportation vehicle is allowed to directly transport an object to be transported of a customer indicated in delivery information received from the order receiving server from a business connection to a delivery destination, that is, a period where the transportation vehicle is allowed to conduct transportation. For example, a desired period (period where a transportation vehicle is allowed to conduct transportation) is a period from a time immediately after the transportation vehicle directly transports an object to be transported to a delivery destination until when the vehicle accepts a mandate for transportation of a new object to be transported.

Responsively, the order receiving server transmits delivery information to a mandatory terminal of a transportation vehicle (mandatory transportation vehicle) closest to a business connection in charge of the customer's object to be transported among a plurality of transportation vehicles allowed to conduct transportation. On the other hand, the mandatory transportation vehicle does not always go to a business connection to get the object to be transported from a place (within a lot of a transportation company) where it accepts a mandate for transportation of the object to be transported when waiting in the lot of the transportation company but is allowed to go to the business connection in charge of the object to be transported from a place (current position of the transportation vehicle closest to the business connection in charge of the object to be transported) where it accepts a mandate for transportation of the object to be transported in a desired period (period where the transportation vehicle is allowed to conduct transportation). As a result, a time required for a transportation vehicle to go to a business connection in charge of an object to be transported from a place (current position of the transportation vehicle closest to the business connection in charge of the object to be transported) where the transportation vehicle accepts a mandate for transportation of the object to be transported can be reduced to enable the transportation vehicle (mandated transportation vehicle) to transport the object quickly according to the customer's request.

In another preferred construction, the mandatory terminal of the transportation vehicle further includes

control means for enabling the transmission means to transmit the current location information of one's own only in a desired period.

In another preferred construction, each of the plurality of ordering terminals includes

means for transmitting, to the order receiving server through the line, transportation start information to the effect that a transportation vehicle specified by the order receiving server as the mandatory transportation vehicle will transport the object to be transported from the business connection, and

the order receiving server includes means for receiving the transportation start information through the line.

Therefore, according to a transportation system, in addition to the advantage of the invention, the ordering terminal is allowed to transmit transportation start information to the order receiving terminal. The order receiving server is responsively allowed to receive the transportation start information to confirm that a transportation vehicle (mandated transportation vehicle) starts transportation of an object to be transported. Accordingly, for example, when the order receiving server fails to receive, within a lapse of a predetermined time from a time when the server transmits delivery information to a mandatory terminal of the transportation vehicle (mandated transportation vehicle), transportation start information of the mandated transportation vehicle (former), the server is allowed to again specify a transportation vehicle having the current position information of a transportation vehicle closest to a business connection in charge of the customer's object to be transported among current position information of a plurality of transportation vehicles as a re-mandated transportation vehicle (new). Next, the order receiving server is allowed to transmit delivery information about the transportation start information yet to be received to a mandatory terminal of the re-mandated transportation vehicle (new). As a result, the transportation vehicle (re-mandated transportation vehicle) is allowed to transport objects reliably and quickly according to a customer's request.

In another preferred construction, each mandatory terminal of the plurality of transportation vehicles includes

means for transmitting transportation completion information to the effect that the object to be transported of the customer is transported to the delivery destination to the order receiving server through the line, and

the order receiving server includes means for receiving the transportation completion information through the line.

Therefore, according to a transportation system, in addition to the advantages of the invention, a mandatory terminal of a mandated transportation vehicle or a mandatory terminal of a re-mandated transportation vehicle (transportation vehicle) is allowed to transmit transportation completion information to the order receiving server. The order receiving server is responsively allowed to receive the transportation completion information to confirm that the mandated transportation vehicle or the re-mandated transportation vehicle (transportation vehicle) finishes transportation of an object to be transported.

In another preferred construction, each of the plurality of ordering terminals includes

means for transmitting, to the order receiving server through the line, transportation start information to the effect that a transportation vehicle specified by the order receiving server as the mandatory transportation vehicle will transport the object to be transported from a business connection, and

means for transmitting transportation completion information to the effect that the object to be transported is transported to the delivery destination to the order receiving server through the line, and

the order receiving server includes:

means for receiving the transportation start information through the line, and

means for receiving the transportation completion information through the line.

In another preferred construction, each mandatory terminal of the plurality of transportation vehicles includes

means for transmitting transportation completion information to the effect that the object to be transported is transported to the delivery destination to the order receiving server through the line,

the order receiving server includes means for receiving the transportation completion information through the line,

each of the order information and the delivery information further includes an electronic mail address of the customer,

the order receiving server includes means for receiving the order information from each of the plurality of ordering terminals through the line to specify an electronic mail address of the customer, and

each mandatory terminal of the plurality of transportation vehicles includes means for transmitting the transportation completion information to the order receiving server through the line, as well as transmitting the transportation completion information to a terminal of the customer by means of an electronic mail through the line.

Therefore, according to a transportation system, in addition to the advantage of the invention, a mandatory terminal of a mandated transportation vehicle or a mandatory terminal of a re-mandated transportation vehicle (transportation vehicle) is allowed to transmit transportation completion information to a customer's terminal. The customer's terminal is responsively allowed to receive the transportation completion information to confirm that the mandated transportation vehicle or the re-mandated transportation vehicle (transportation vehicle) finishes transportation of an object to be transported (that the customer's object to be transported arrives at a delivery destination safely).

In another preferred construction, each of the plurality of ordering terminals includes

means for transmitting, to the order receiving server through the line, transportation start information to the effect that a transportation vehicle specified by the order receiving server as the mandatory transportation vehicle will transport the object to be transported of the customer from the business connection, and

means for transmitting transportation completion information to the effect that the object to be transported is transported to the delivery destination to the order receiving server through the line,

the order receiving server includes:

means for receiving the transportation start information through the line, and

means for receiving the transportation completion information through the line,

each of the order information and the delivery information further includes an electronic mail address of the customer,

the order receiving server further includes means for receiving the order information from each of the plurality of ordering terminals through the line to specify an electronic mail address of the customer, and

each mandatory terminal of the plurality of transportation vehicles includes means for transmitting the transportation completion information to the order receiving server through the line, as well as transmitting the transportation completion information to a terminal of the customer by means of an electronic mail through the line.

In another preferred construction, the plurality of transportation vehicles are transportation vehicles of a plurality of transportation companies.

Therefore, according to a transportation system, in addition to any one of the advantages of the invention, since a plurality of transportation vehicles are transportation vehicles of a plurality of transportation companies, an order receiving server is allowed to transmit delivery information to a mandatory terminal of a transportation vehicle (mandated transportation vehicle) closest to a business connection in charge of an object to be transported among transportation vehicles allowed to conduct transportation of the plurality of transportation companies.

More specifically, even when a customer is at a place (unfamiliar place) different from an ordinary one, only the transmission of order information to the same (familiar) ordinary order receiving server enables the order receiving server, in place of the customer, to specify a transportation vehicle (mandatory transportation vehicle) closest to a business connection in charge of the customer's object to be transported among transportation vehicles allowed to conduct transportation of the plurality of transportation companies. In other words, customers are allowed to specify with ease a transportation vehicle closest to a business connection in charge of an object to be transported through an order receiving server.

In another preferred construction, at least one of the plurality of transportation vehicles is a vehicle mainly for carrying a customer from a boarding place to an alighting place.

Therefore, according to a transportation system, in addition to any one of the advantages of the invention, transportation vehicles include, other than those for directly transporting an object to be transported from a business connection to a delivery destination, vehicles mainly for carrying customers from a boarding place to an alighting place.

For example, a desired period of a transportation vehicle (period where a transportation vehicle is allowed to conduct transportation) for directly transporting an object to be transported from a business connection to a delivery destination is a period from a time when the transportation vehicle directly transports the object to be transported to the delivery destination until when the same is mandated to transport a new object to be transported.

On the other hand, a desired period (period where a transportation vehicle is allowed to conduct transportation) of a vehicle for mainly carrying customers from a boarding place to an alighting place is, for example, a period from a time when the vehicle carries a customer to an alighting place (taking the customer down at an alighting place) until when the same has a new customer on board.

Here, as an example, when a transportation vehicle is allowed to conduct transportation for a long time period, that is, when a long time has elapsed after the transportation vehicle directly transports an object to be transported to a delivery destination, the transportation vehicle will return to a lot of the transportation company to wait. As a result, transportation vehicles allowed to conduct transportation concentrate in the lot of the transportation company, so that a probability will be lowered that a transportation vehicle allowed to conduct transportation will be near a business connection in charge of a customer's object to be transported.

On the other hand, when a transportation vehicle mainly for carrying a customer from a boarding place to an alighting place is allowed to conduct transportation for a long time period, that is, when a long time has elapsed after the vehicle carries the customer to the alighting place, the vehicle will run on the roads for carrying a new customer. As a result, vehicles allowed to conduct transport will scatter on the roads, so that a probability will be increased that vehicles allowed to conduct transportation will be near a business connection in charge of a customer's object to be transmitted. This accordingly produces an advantage that a transportation vehicle (vehicle mainly for carrying a customer from a boarding place to an alighting place) can transport objects reliably and quickly according to a customer's request.

Vehicle mainly for carrying customers from a boarding place to an alighting place is, for example, a taxi. Taxi serves mainly for carrying customers from a boarding place to an alighting place, as well as transporting objects in a desired period.

In another preferred construction, a location of a business connection in charge of an object to be transported of the customer and/or a location of a delivery destination are in a store with round-the-clock operation.

Therefore, according to a transportation system, in addition to any one of the advantages of the invention, customers are allowed to deposit objects to be transported at a store with round-the-clock operation (business connection in charge of an object to be transported). This produces an advantage that customers will not be bound to time after depositing objects to be transported.

Moreover, transportation vehicles (mandated transportation vehicles) are allowed to deposit objects to be transported at a store with round-the-clock operation (delivery destination of the object to be transported). This produces an advantage that transportation vehicles will not be bound to time after depositing objects to be transported.

Stores with round-the-clock operation are in other words stores provided with a means for enabling round-the-clock deposition of a customer's object to be transported.

According to the second aspect of the invention, a mandatory terminal of a transportation vehicle for directly transporting an object to be transported from a business connection to a delivery destination, comprises

transmission means for periodically transmitting current location information of its own to an order receiving server through a line,

control means for enabling the transmission means to transmit the current location information of its own only in a desired period, and

means for receiving delivery information including a location of a business connection in charge of an object to be transported and a location of a delivery destination from the order receiving server through the line.

Therefore, a mandatory terminal of a transportation vehicle for directly transporting an object to be transported from a business connection to a delivery destination according to the invention enables transportation of an object to be transported in a desired period.

In the preferred construction, the mandatory terminal of a transportation vehicle further comprises

means for transmitting, to the order receiving server through the line, transportation start information to the effect that a transportation vehicle specified by the order receiving server as the mandatory transportation vehicle will transport the object to be transported from the business connection.

In another preferred construction, the mandatory terminal of a transportation vehicle further comprises

means for transmitting transportation completion information to the effect that the object to be transported of the customer is transported to the delivery destination to the order receiving server through the line.

In another preferred construction, the mandatory terminal of a transportation vehicle further comprises

means for transmitting, to the order receiving server through the line, transportation start information to the effect that a transportation vehicle specified by the order receiving server as the mandatory transportation vehicle will transport the object to be transported from the business connection, and

means for transmitting transportation completion information to the effect that the object to be transported is transported to the delivery destination to the order receiving server through the line.

According to the third aspect of the invention, an order receiving server for receiving an order for transportation of an object to be transported, comprises

means for receiving current location information of one's own from each mandatory terminal of a plurality of transportation vehicles through the line to specify each current location information of the plurality of transportation vehicles,

means for receiving order information including a location of a business connection in charge of a customer's object to be transported and a location of a delivery destination from a plurality of ordering terminals through the line to specify a location of the business connection in charge of the object to be transported of the customer and a location of the delivery destination,

means for specifying each transportation vehicle having current location information of a transportation vehicle closest to a location of the business connection in charge of the object to be transported of the customer among current location information of the plurality of transportation vehicles as a mandatory transportation vehicle, and

means for transmitting delivery information including a location of the business connection in charge of the object to be transported of the customer and a location of the delivery destination to each mandatory terminal of the transportation vehicle specified as the mandatory transportation vehicle through the line.

Therefore, an order receiving server for receiving an order for a customer's object to be transported according to the invention transmits delivery information to a mandatory terminal of a transportation vehicle (mandated transportation vehicle) closest to a business connection in charge of a customer's object to be transported among a plurality of transportation vehicles allowed to conduct transportation. The mandated transportation vehicle does not always go to a business connection to get an object to be transported from a place (in a lot of a transportation company) where it accepts a mandate for transportation of the object to be transported when waiting in the lot of the transportation company but is allowed to go to the business connection in charge of the object to be transported from a place (current position of the transportation vehicle closest to the business connection in charge of the object to be transported) where it accepts a mandate for transportation of the object to be transported in a desired period (period where the transportation vehicle is allowed to conduct transportation). As a result, a time required for a transportation vehicle to go to a business connection in charge of an object to be transported from a place (current position of the transportation vehicle closest to the business connection in charge of the object to be transported) where the transportation vehicle accepts a mandate for transportation of the object to be transported can be reduced to enable the transportation vehicle (mandated transportation vehicle) to transport the object quickly according to the customer's request.

Therefore, an order receiving server for receiving an order for a customer's object to be transported according to the invention transmits delivery information to a mandatory terminal of a transportation vehicle (mandated transportation vehicle) closest to a business connection in charge of a customer's object to be transported among a plurality of transportation vehicles allowed to conduct transportation. The mandated transportation vehicle does not always go to a business connection to get an object to be transported from a place (in a lot of a transportation company) where it accepts a mandate for transportation of the object to be transported when waiting in the lot of the transportation company but is allowed to go to the business connection in charge of the object to be transported from a place (current position of the transportation vehicle closest to the business connection in charge of the object to be transported) where it accepts a mandate for transportation of the object to be transported in a desired period (period where the transportation vehicle is allowed to conduct transportation). As a result, a time required for a transportation vehicle to go to a business connection in charge of an object to be transported from a place (current position of the transportation vehicle closest to the business connection in charge of the object to be transported) where the transportation vehicle accepts a mandate for transportation of the object to be transported can be reduced to enable the transportation vehicle (mandated transportation vehicle) to transport the object quickly according to the customer's request.

In another preferred construction, the order receiving server for receiving an order for transportation of an object to be transported, further comprises

means for receiving, through the line, the transportation start information sent from a transportation vehicle specified as the mandatory transportation vehicle to the effect that the transportation vehicle will transport the object to be transported from the business connection.

In another preferred construction, the order receiving server for receiving an order for transportation of an object to be transported, further comprises

means for receiving, through the line, transportation completion information sent from a transportation vehicle specified as the mandatory transportation vehicle to the effect that the object to be transported is transported to the delivery destination.

In another preferred construction, the order receiving server for receiving an order for transportation of an object to be transported, further comprises

means for receiving, through the line, the transportation start information sent from a transportation vehicle specified as the mandatory transportation vehicle to the effect that the transportation vehicle will transport the object to be transported from the business connection, and

means for receiving, through the line, transportation completion information sent from a transportation vehicle specified as the mandatory transportation vehicle to the effect that the object to be transported is transported to the delivery destination.

According to another aspect of the invention, a transportation method using a communication line, comprising the steps of

a first step of periodically transmitting each current location information of one's own from each mandatory terminal of a plurality of transportation vehicles for directly transporting an object to be transported from a business connection to a delivery destination to an order receiving server through a line only in a desired period,

a second step of receiving the current location information of one's own at the order receiving server from each mandatory terminal of the plurality of transportation vehicles through the line to specify each current location information of the plurality of transportation vehicles,

a third step of transmitting order information including a location of a business connection in charge of a customer's object to be transported and a location of a delivery destination from an ordering terminal for placing an order for transportation of a customer's object to be transported to the order receiving server through the line,

a fourth step of receiving the order information including a location of a business connection in charge of an object to be transported of the customer and a location of a delivery destination at the order receiving server from the ordering terminal through the line to specify a location of the business connection in charge of the object to be transported of the customer and a location of the delivery destination,

a fifth step of specifying a transportation vehicle having current location information of a transportation vehicle closest to the location of the business connection in charge of the object to be transported of the customer among current location information of the plurality of transportation vehicles as a mandatory transportation vehicle, and

a sixth step of transmitting and receiving delivery information including a location of a business connection in charge of a customer's object to be transported and a location of a delivery destination from/at the order receiving sever to/from the mandatory terminal of a transportation vehicle specified as the mandatory transportation vehicle through the line.

In the preferred construction, the transportation method using a communication line, further comprises

after the sixth step, a seventh step of transmitting and receiving transportation start information to the effect that the transportation vehicle specified by the order receiving server as the mandatory transportation vehicle will transport the object to be transported of the customer from the business connection from/at the ordering terminal to/from the order receiving server through the line.

In another preferred construction, the transportation method using a communication line, further comprises

after the sixth step, an eighth step of transmitting and receiving transportation completion information to the effect that the object to be transported of the customer is transported to the delivery destination from/at the mandatory terminal of the transportation vehicle specified by the order receiving server as the mandatory transportation vehicle to/from the order receiving server through the line.

In another preferred construction, the transportation method using a communication line, further comprises

after the sixth step, a seventh step of transmitting and receiving transportation start information to the effect that the transportation vehicle specified by the order receiving server as the mandatory transportation vehicle will transport the object to be transported of the customer from the business connection from/at the ordering terminal to/from the order receiving server through the line, and

after the sixth step, an eighth step of transmitting and receiving transportation completion information to the effect that the object to be transported of the customer is transported to the delivery destination from/at the mandatory terminal of the transportation vehicle specified by the order receiving server as the mandatory transportation vehicle to/from the order receiving server through the line.

In another preferred construction, the transportation method using a communication line, further compries

after the sixth step, an eighth step of transmitting and receiving transportation completion information to the effect that the object to be transported of the customer is transported to the delivery destination from/at the mandatory terminal of the transportation vehicle specified by the order receiving server as the mandatory transportation vehicle to/from the order receiving server through the line, wherein

each of the order information and the delivery information further includes information of an electronic mail address of the customer, and which further comprises

after the third step and before the sixth step, a step of receiving the order information at the order receiving server from the ordering terminal through the line to specify an electronic mail address of the customer, and

a step of transmitting and receiving the transportation completion information from/at the mandatory terminal of the transportation vehicle specified by the order receiving server as the mandatory transportation vehicle to/from a terminal of the customer by an electronic mail through the line, as well as executing the eighth step.

In another preferred construction, the transportation method using a communication line, further comprises

after the sixth step, a seventh step of transmitting and receiving transportation start information to the effect that the transportation vehicle specified by the order receiving server as the mandatory transportation vehicle will transport the object to be transported of the customer from the business connection from/at the ordering terminal to/from the order receiving server through the line,

after the sixth step, an eighth step of transmitting and receiving transportation completion information to the effect that the object to be transported of the customer is transported to the delivery destination from/at the mandatory terminal of the transportation vehicle specified by the order receiving server as the mandatory transportation vehicle to/from the order receiving server through the line, wherein

each of the order information and the delivery information further includes information of an electronic mail address of the customer, and which further comprises

after the third step and before the sixth step, a step of receiving the order information at the order receiving server from the ordering terminal through the line to specify an electronic mail address of the customer, and

a step of transmitting and receiving the transportation completion information from/at the mandatory terminal of the transportation vehicle specified by the order receiving server as the mandatory transportation vehicle to/from a terminal of the customer by an electronic mail through the line, as well as executing the eighth step.

In another preferred construction, the plurality of transportation vehicles are transportation vehicles of a plurality of transportation companies.

In another preferred construction, at least one of the plurality of transportation vehicles is a vehicle mainly for carrying a customer from a boarding place to an alighting place.

In another preferred construction, a location of a business connection in charge of an object to be transported of the customer and/or a location of a delivery destination are in a store with round-the-clock operation.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing an example of a structure of a transportation system according to a first embodiment of the present invention;

FIG. 2 is a diagram showing a town for use in explaining the first embodiment of the present invention;

FIG. 3 is a block diagram showing an example of a structure of a transportation system according to a second embodiment of the present invention;

FIG. 4 is a diagram showing a town for use in explaining the second embodiment of the present invention;

FIG. 5 is a block diagram for use in explaining a structure of a mandatory terminal of the first embodiment of the present invention;

FIG. 6 is a block diagram for use in explaining a structure of an ordering terminal of the first embodiment of the present invention;

FIG. 7 is a block diagram for use in explaining a structure of an order receiving server of the first embodiment of the present invention;

FIG. 8 is a flow chart for use in explaining a transportation method of the transportation system according to the first embodiment of the present invention;

FIG. 9 is a block diagram for use in explaining a structure of a mandatory terminal of the second embodiment of the present invention;

FIG. 10 is a block diagram for use in explaining a structure of an order receiving server of the second embodiment of the present invention;

### DESCRIPTION OF THE PREFERRED EMBODIMENTS

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

In the following, description will be made of a transportation system, a transportation method, a mandatory terminal of a transportation vehicle, an ordering terminal and an order receiving server according to embodiments of the present invention with reference to the drawings.

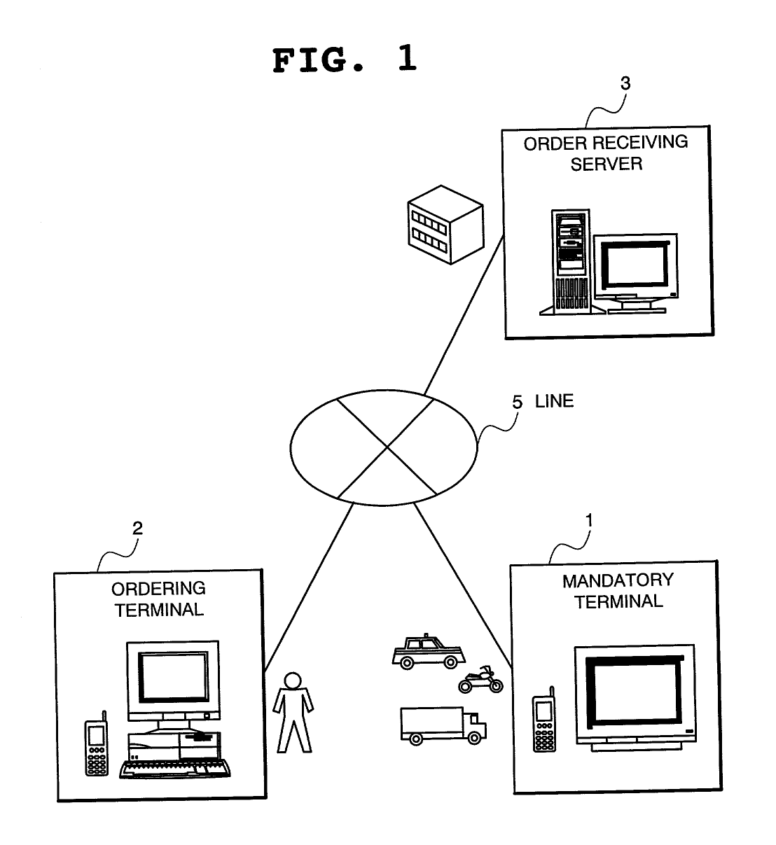

FIG. 1 is a block diagram showing an example of a structure of a transportation system according to a first embodiment of the present invention.

(First Embodiment)

First, as illustrated in FIG. 1, the transportation system of the first embodiment includes a plurality of mandatory terminals 1 of transportation vehicles, a plurality of customers' ordering terminals 2 and an order receiving server 3, all of which are structured to be connectable to a line 5.

Here, the line 5 is, for example, the Internet which connects to lines all over the world to cover the whole world like a spider web (WWW: World Wide Web), a leased line or the like. In addition, the line 5 may be a line, whether wired or wireless, for bi-directionally transmitting information between the mandatory terminal 1 and the order receiving server 3, between the mandatory terminal 1 and the ordering terminal 2, between the order receiving server 3 and the ordering terminal 2, and among the mandatory terminal 1, the ordering terminal 2 and the order receiving server 3.

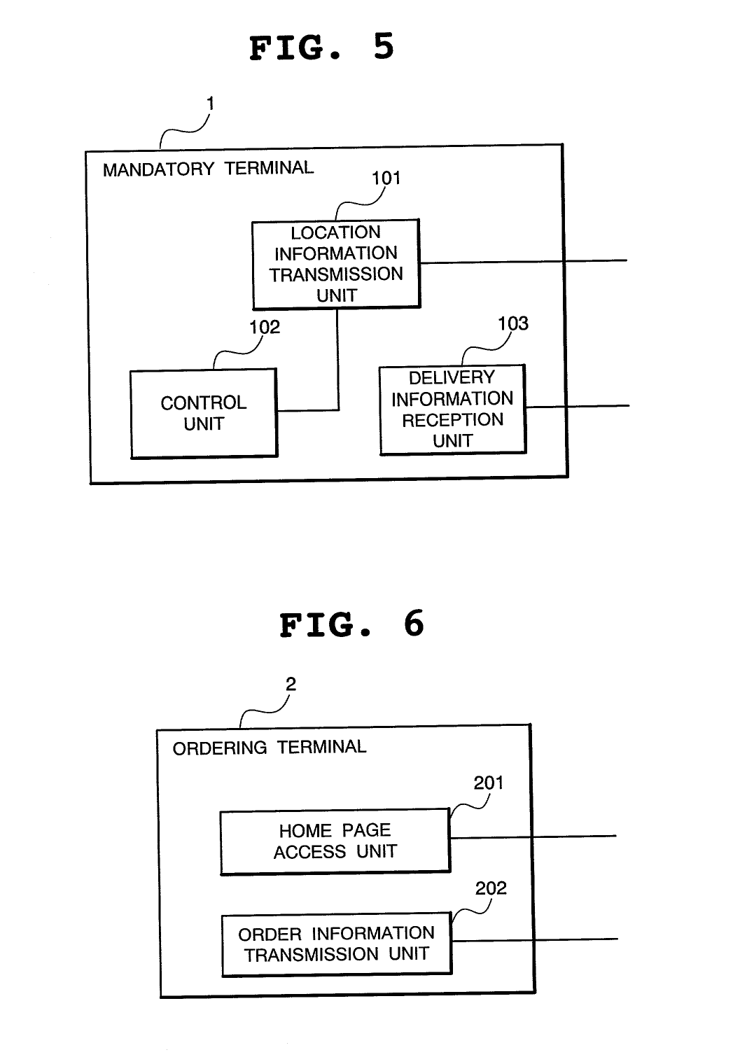

The mandatory terminal 1 of a transportation vehicle for directly transporting an object to be transported from a business connection to a delivery destination includes, as illustrated in FIG. 5, a location information transmission unit 101 for periodically transmitting current location information of one's own to the order receiving server 3 through the line 5, a control unit 102 for enabling the transmission unit 101 to transmit current location information of one's own only in a desired period, and a delivery information reception unit 103 for receiving delivery information including a location of a business connection in charge of a customer's object to be transported and a location of a delivery destination from the order receiving server 3 through the line.

The mandatory terminal 1 of the transportation vehicle here is, for example, a personal computer (notebook-sized personal computer, a small-sized portable personal computer), a portable phone or the like.

The transportation vehicle is, for example, a motorcycle (bike), a light four-wheeled car, an automobile or the like.

The ordering terminal 2 for ordering a customer's object to be transported includes, as illustrated in FIG. 6, an access unit 201 such as a WWW browser for enabling access to a home page through the line 5 and an order information transmission unit 202 for transmitting order information including a location of a business connection in charge of a customer's object to be transported and a location of a delivery destination to the order receiving server 3 through the line 5.

The customer's ordering terminal 2 here is, for example, a personal computer (desk-top personal computer, notebook-sized personal computer), a portable phone or the like.

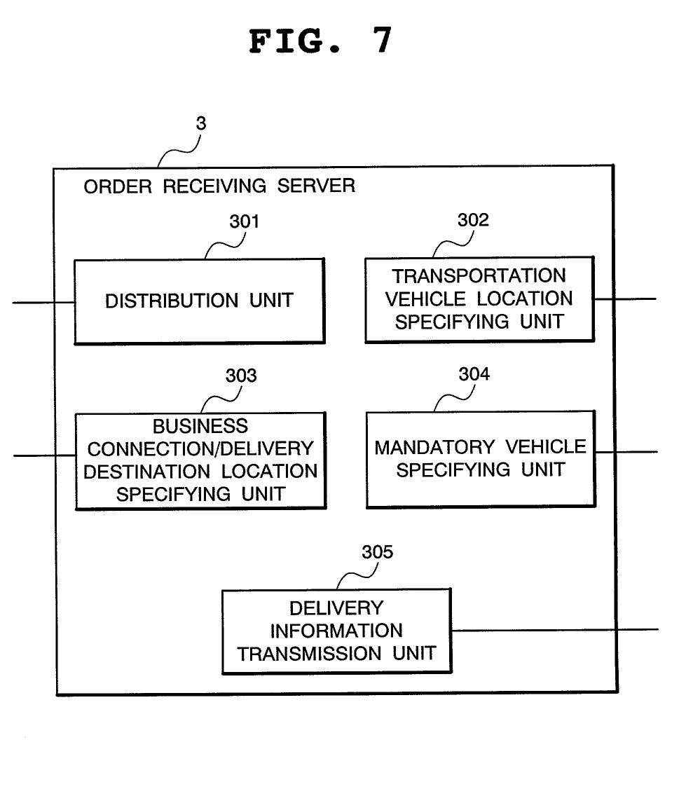

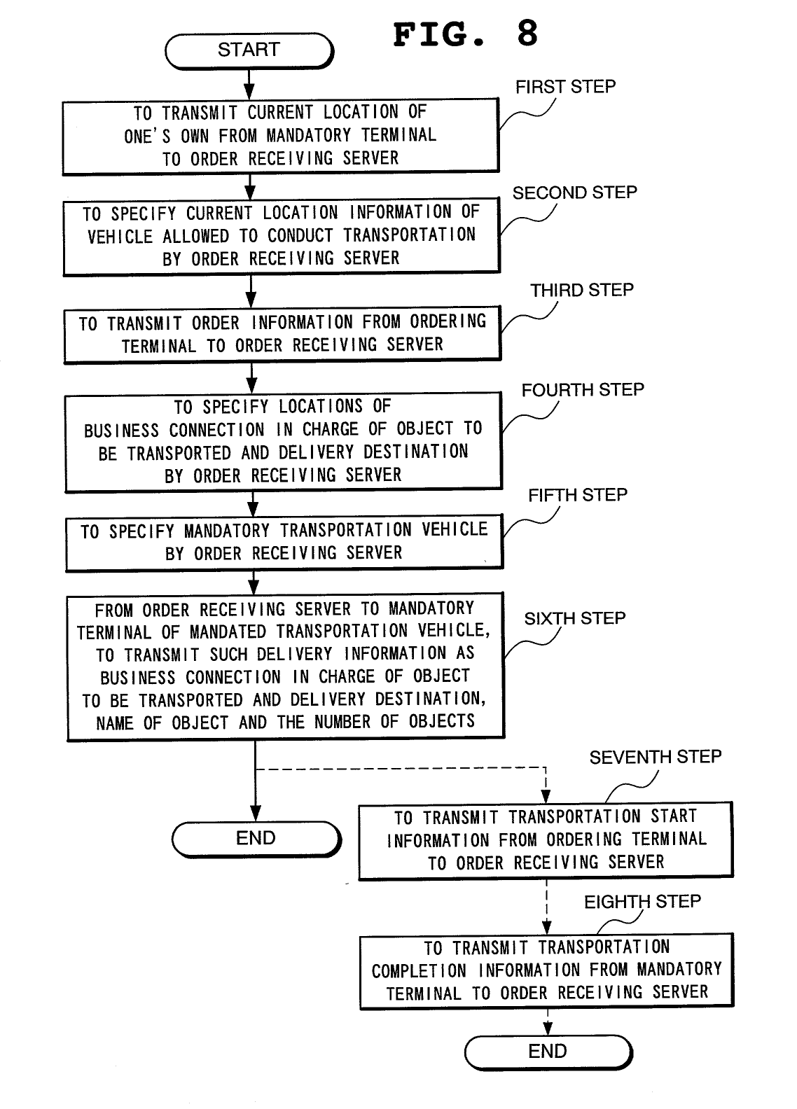

The order receiving server 3 for receiving an order for a customer's object to be transported includes, as illustrated in FIG. 7, a distribution unit 301 for distributing, on a line, a file and the like in the form of a hyper text markup language which enables set-up of a home page of an electronic store, a transportation vehicle location specifying unit 302 for receiving current location information of one's own from each mandatory terminal 1 of a plurality of transportation vehicles through the line to specify current location information of the plurality of transportation vehicles, a business connection•delivery destination location specifying unit 303 for receiving delivery information including a location of a business connection in charge of a customer's object to be transported and a location of a delivery destination from each of the plurality of ordering terminals 2 through the line 5 to specify each location of the business connection in charge of the customer's object to be transported and each location of the delivery destination, a mandatory vehicle specifying unit 304 for specifying, as a mandatory vehicle, each transportation vehicle whose current location information is closest to the location of the business connection in charge of the customer's object to be transported among current location information of the plurality of transportation vehicles, and a delivery information transmission unit 305 for transmitting delivery information including the location of the business connection in charge of the customer's object to be transported and the location of the delivery destination to each mandatory terminal 1 of a transportation vehicle specified as the mandatory transportation vehicle through the line 5.

The order receiving server 3 here is, for example, a so-called server (office computer whose hard disk has a large capacity), a personal computer or the like. In addition, the order receiving server 3 may be composed of a plurality of servers or a plurality of personal computers.

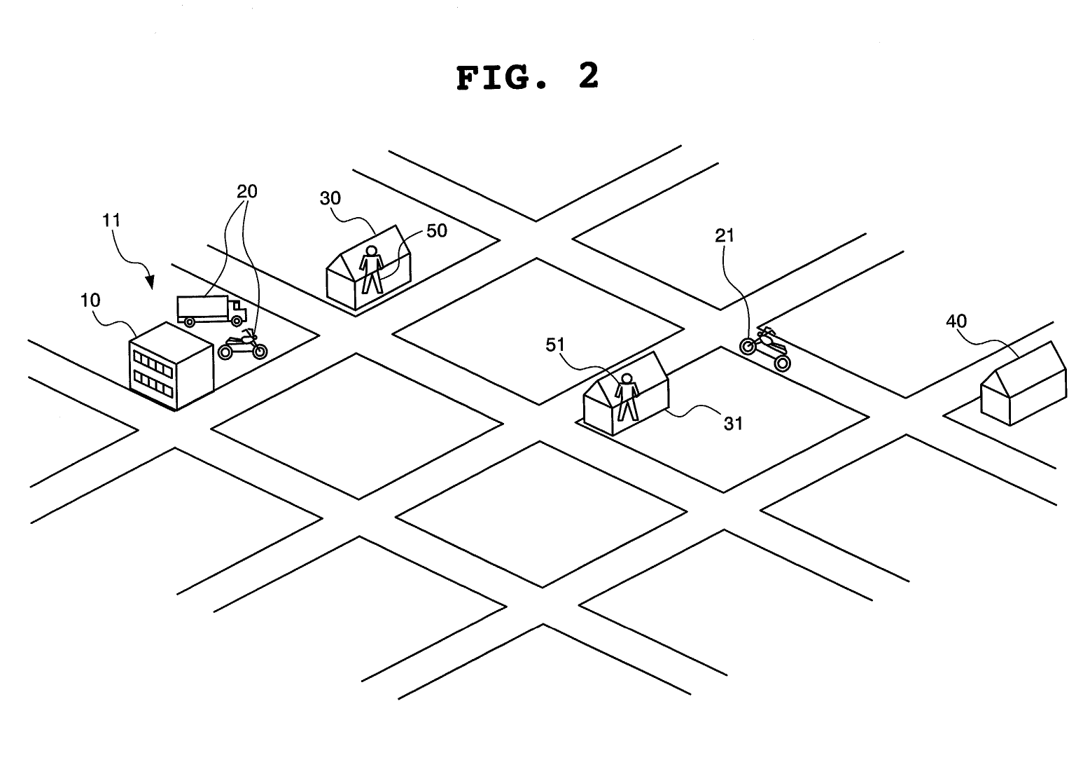

Next, with reference to FIG. 1 and the flow charts of FIGS. 2 and 8, a transportation method of the first embodiment will be described in detail.

[First Step]

First, a driver of a transportation vehicle 20 periodically transmits current location information of its own 20 to the order receiving server 3 through the line 5 by means of the control unit 102 of the mandatory terminal 1 in a period where direct transportation of a customer's object to be transported from a business connection to a delivery destination is allowed. The control unit 102 here is, for example, provided with a button for enabling the current location information 20 to be transmitted and pressing the button by the driver of the transportation vehicle 20 enables the mandatory terminal 1 of the transportation vehicle 20 to transmit information. Further press of the button by the driver disables the mandatory terminal 1 to transmit the current location information of its own 20.

The mandatory terminal 1 of the transportation vehicle 20 is, for example, a GPS (Global Positioning System) receiver (not shown) which receives a GPS radio wave from a satellite to periodically transmit the current location information of its own 20 (latitude longitude) to the order receiving server 3. Periodically denotes, for example, every 10 minutes, every 5 minutes, every 1 minute, every 30 seconds, every one second or the like, which interval can be appropriately set in consideration of a processing capacity of the order receiving server 3.

A driver of a transportation vehicle 21 also periodically transmits the current location information of its own 21 to the order receiving server 3 through the line 5 by means of the control unit 102 after directly transporting an object to be transported to a delivery destination until returning to a lot 11 of a transportation company 10.

Moreover, a plurality of mandatory terminals of other transportation vehicles periodically transmit current location information of their own to the order receiving server 3 through the line 5 in the same manner.

[Second Step]

Responsively, the order receiving server 3 receives the current location information 20 and 21 of the transportation vehicles 20 and 21 through the line 5 to specify the current location information 20 and 21 (latitude•longitude) of the transportation vehicles 20 and 21 allowed to conduct transportation.

[Third Step]

On the other hand, in a case where a customer 51 wants an object to be transported to be transported directly from a business connection 31 to a delivery destination 40, the customer 51 accesses a home page (not shown) of an electronic store through the line 5 by means of a WWW browser etc. of the ordering terminal 2. Then, on a display means (not shown) of the ordering terminal 2, a home page of an electronic store (order receiving server) is displayed. Here, the customer 51 inputs, as input items (not shown) displayed on the home page screen, such order information as the address 31 of the business connection in charge of the object to be transported, an address of the delivery destination 40 of the object to be transported, a name of the object to be transported, the number of objects to be transported, a name of the customer 51, a telephone number of the customer 51, a name of a recipient, and a telephone number of the recipient. Next, when the customer 51 clicks an ordering settlement button (not shown) displayed on the home page screen, the ordering terminal 2 of the customer 51 transmits the order information to the ordering server 3 through the line 5.

Assume that the input items, the address 31 of the business connection in charge of an object to be transported and an address of the delivery destination 40 of an object to be transported, are indispensable items to be input and that unless they are input, the ordering settlement button can not be clicked.

As addresses of a business connection and a delivery destination of an object to be transported, such character information may be input as a name of prefecture, names of city, ward, town or village and the number of residence or a radio button of a prefecture name or the like may be selected.

[Fourth Step]

Responsively, the order receiving server 3 receives the order information of the customer 51 through the line 5 to extract, from the order information, the address 31 of the business connection in charge of the object to be transported, the address of the delivery destination 40 of the object to be transported, the name of the object to be transported, the number of objects to be transported, the address 31 of the customer 51, the telephone number of the customer 51 and the like. Thereafter, the order receiving server 3 is allowed to specify the location 31 (latitude longitude) of the business connection in charge of the object to be transported of the customer 51 and the location 40 (latitude•longitude) of the delivery destination using an (address)-(latitude•longitude) conversion table prepared in advance.

[Fifth Step]

Next, among the current location information (latitude•longitude) 20 and 21 of the plurality of transportation vehicles, the order receiving server 3 is allowed to specify the transportation vehicle 21 having the current location information of a transportation vehicle closest to the location 31 (latitude•longitude) of the business connection in charge of the object to be transported of the customer 51 as a mandatory transportation vehicle.

[Sixth Step]

Next, the order receiving server 3 transmits such extracted delivery information as the address 31 of the business connection in charge of the object to be transported of the customer 51, the address of the delivery destination 40 of the object to be transported, the name of the object to be transported, the number of objects to be transported, the name of the customer 51, the telephone number of the customer 51, the name of the recipient, and the telephone number of the recipient to the mandatory terminal 1 of the transportation vehicle 21 specified as a mandatory transportation vehicle.

Responsively, the mandatory terminal 1 of the transportation vehicle 21 receives the delivery information to specify the address 31 of the business connection in charge of the object to be transported and the address of the delivery destination 40 of the object to the transported. Assume here that the sixth step is executed.

Next, the driver of the transportation vehicle 21 goes to the address 31 of the business connection in charge of the object to be transported to take the object to be transported of the customer 51. Then, the driver of the transportation vehicle 21 goes to the address 40 of the delivery destination of the object to be transported and hands the object to be transported over to the recipient designated by the customer 51. At this time, the driver of the transportation vehicle 21 receives a certificate of the recipient's seal impression or his signature.

An address included in the delivery information may be character information such as a name of prefecture, a name of city, ward, town or village, the number of residence, etc. or information about latitude longitude. Based on the information about latitude longitude (the business connection 31 and delivery destination 40), the mandatory terminal 1 of the transportation vehicle 21 may have the business connection 31 and the delivery destination 40 displayed on map information which is displayed in a display means (not shown) of the mandatory terminal 1. This enables the driver of the transportation vehicle 21 to go to the business connection 31 and the delivery destination 40 with ease.

According to the transportation system, the transportation method, the mandatory terminal of a transportation vehicle, the ordering terminal and the order receiving server of the first embodiment of the present invention, the mandatory terminals of the plurality of transportation vehicles 20 and 21 are allowed to transmit current location information of their own to the order receiving server 3 in a desired period. The desired period here is a period where the drivers of the transportation vehicles 20 and 21 are allowed to directly transport, from a business connection to a delivery destination, an object to be transported of a customer indicated in delivery information received from the order receiving server 3, that is, a period where the transportation vehicles 20 and 21 are allowed to conduct transportation. The desired period (where a transportation vehicle is allowed to conduct transportation) is, for example, a period after the transportation vehicle 21 directly transports the object to be transported to the delivery destination until accepting a mandate for transportation of a new object to be transported, a period where the transportation vehicle 20 waits in the lot 11 of the transportation company 10 or other period.

On the other hand, the order receiving server 3 transmits the delivery information to the mandatory terminal of the transportation vehicle 21 (mandated transportation vehicle) closest to the business connection 31 in charge of the object to be transported of the customer 51 among the plurality of the transportation vehicles 20 and 21 allowed to conduct transportation. The mandated transportation vehicle 21 does not always go to the business connection 51 in the charge of the object to be transported from the position 11 (in the lot 11 of the transportation company 10) where transportation of the object to be transported is mandated while waiting in the lot 11 of the transportation company 10 but is allowed to go to the business connection 51 in charge of the object to be transported from the position 21 (the current position 21 of the transportation vehicle closest to the business connection in charge of the object to be transported) where transportation of the object to be transported is mandated in a desired period (period where the transportation vehicle is allowed to conduct transportation). This enables reduction in a time for the transportation vehicle 21 to go to the business connection in charge of the object to be transported from the position (current position of the transportation vehicle closest to the business connection in charge of the object to be transported) where the vehicle 21 accepts a mandate for transportation of the object to be transported, thereby enabling the transportation vehicle (mandated transportation vehicle) 21 to transport objects quickly according to a customer's request.

It is clearly understood that in a case where at the third step, the customer 50, in place of the customer 51, wants an object to be transported to be transported directly from the business connection 30 to the delivery destination 40, among the plurality of transportation vehicles 20 and 21 allowed to conduct transportation, the order receiving server 3 specifies the transportation vehicle 20 closest to the business connection 30 in charge of the object to be transported of the customer 50 as a mandatory transportation vehicle (Fourth Step).

The present invention is also realized by further including, after the sixth step of the first embodiment, a seventh step of transmitting, from the ordering terminal 2 of the customer 51 to the order receiving server 3 through the line 5, transportation start information to the effect that the transportation vehicle 21 specified as a mandatory transportation vehicle by the order receiving server 3 will transport the object to be transported of the customer 51 from the business connection 31.

According to the present embodiment, the customer 51 is allowed to transmit transportation start information to the order receiving server 3 after leaving the object to be transported with the driver of the transportation vehicle 21.

The order receiving server 3 responsively receives the transportation start information to confirm that the transportation vehicle 21 (mandated transportation vehicle) starts transportation of the object to be transported. Accordingly, for example, when the order receiving server 3 fails to receive transportation start information of the mandated transportation vehicle 21 (former) before a predetermined time elapses after the server transmits the delivery information to the mandatory terminal of the transportation vehicle 21 (mandated transportation vehicle), the server is allowed to again specify a transportation vehicle having the current location information of a transportation vehicle closest to the business connection in charge of the customer's object to be transported among current location information of the plurality of the transportation vehicles as a re-mandated transportation vehicle 20 (new). Next, the order receiving server 3 is allowed to transmit delivery information of the transportation start information yet to be received to the mandatory terminal of the re-mandated transportation vehicle 20 (new). This enables the transportation vehicle 20 (re-mandated transportation vehicle) to transport objects reliably and quickly according to a customer's request.

The present invention can be also implemented by further including, after the sixth step of the first embodiment, an eighth step of transmitting transportation completion information to the effect that the object to be transported of the customer 51 has been transported to the delivery destination 40 from the mandatory terminal of the transportation vehicle 21 specified by the order receiving server 3 as a mandatory transportation vehicle to the order receiving server 3 through the line 5.

According to the present embodiment, after handing the object to be transported over to the recipient designated by the customer 51, the driver of the transportation vehicle 21 is allowed to transmit the transportation completion information to the order receiving server 3.

The order receiving server 3 has an advantage of responsively receiving the transportation completion information to confirm that the mandated transportation vehicle 21 (transportation vehicle) completes transportation of the object to be transported.

(Second Embodiment)

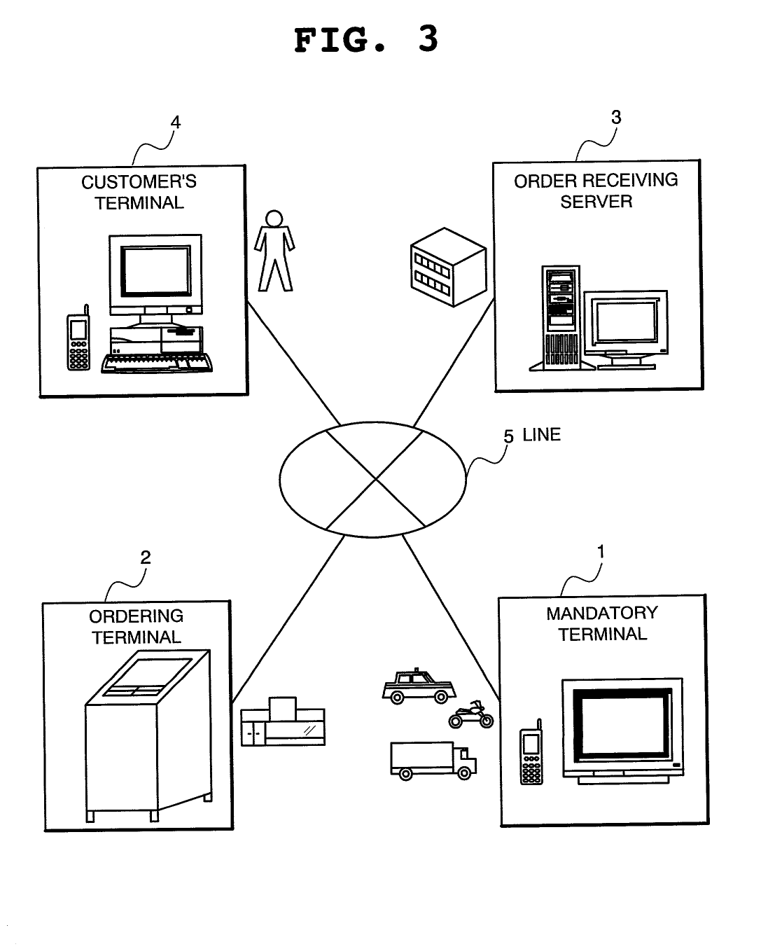

Next, description will be made of a transportation system, a transportation method, a mandatory terminal of a transportation vehicle, an ordering terminal and an order receiving server according to a second embodiment of the present invention with reference to FIG. 3.

FIG. 3 is a block diagram showing an example of a structure of a transportation system according to the second embodiment of the present invention. No description will be made of the same parts of the transportation system, the transportation method, the mandatory terminal of a transportation vehicle, the ordering terminal and the order receiving server as those of the first embodiment and description will be made only of the different parts.

First, as illustrated in FIG. 3, the transportation system of the second embodiment includes a plurality of mandatory terminals 1 of transportation vehicles, a plurality of ordering terminals 2, an order receiving server 3 and a customer's terminal 4, all of which are structured to be connectable to a line 5.

Assume that order information and delivery information each include information about a customer's electronic mail address.

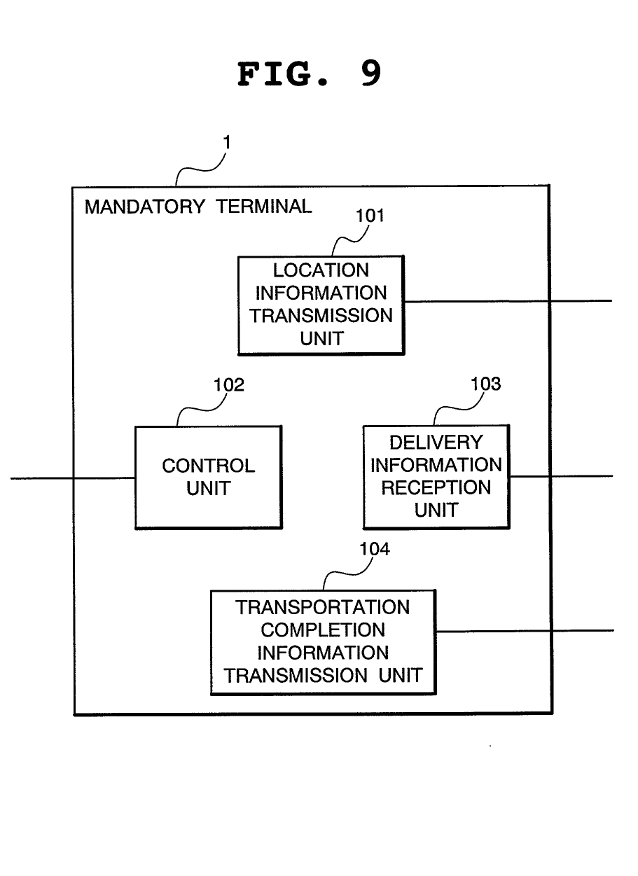

The mandatory terminal 1 of the transportation vehicle, as illustrated in FIG. 9, further includes a transportation completion information transmission unit 104 for transmitting transportation completion information to the order receiving server 3 through the line 5, as well as transmitting transportation completion information to the customer's terminal 4 by means of an electronic mail through the line 5.

Unlike the first embodiment, the ordering terminal 2 for ordering a customer's object to be transported may not include such an access means as a WWW browser which enables access to a home page through the line 5. The ordering terminal 2 only needs to include a means for transmitting order information including a location of a business connection in charge of an object to be transported and a location of a delivery destination to the order receiving server 3 through the line 5.

The ordering terminal 2 here is, for example, a cash register, a personal computer (desk-top PC, a notebook-sized PC) or the like.

In addition, the ordering terminal 2 is assumed to be disposed in a store with round-the-clock operation. Store with round-the-clock operation here is, for example, a convenience store, a gas station, or the like.

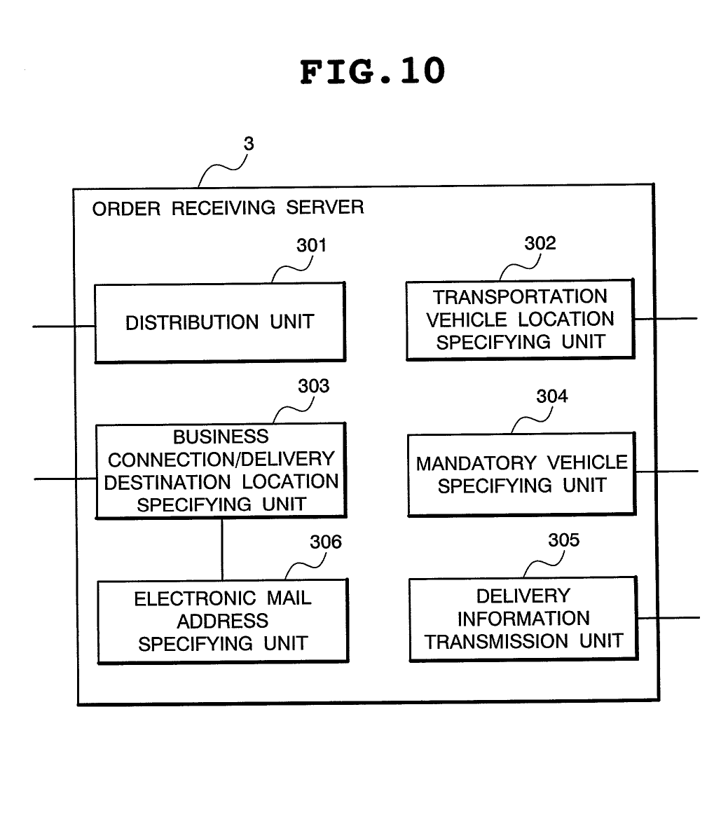

In addition to the components of the first embodiment, the order receiving server 3, as illustrated in FIG. 10, includes an electronic mail address specifying unit 306 for receiving order information from the ordering terminal 2 through the line 5 to specify a customer's electronic mail address.

The customer's terminal 4 includes a means for transmitting transportation completion information from the mandatory terminal 1 of the transportation vehicle by means of an electronic mail through the line 5.

The customer's terminal 4 here is, for example, a personal computer (desk-top PC, a notebook-sized PC), a portable phone or the like.

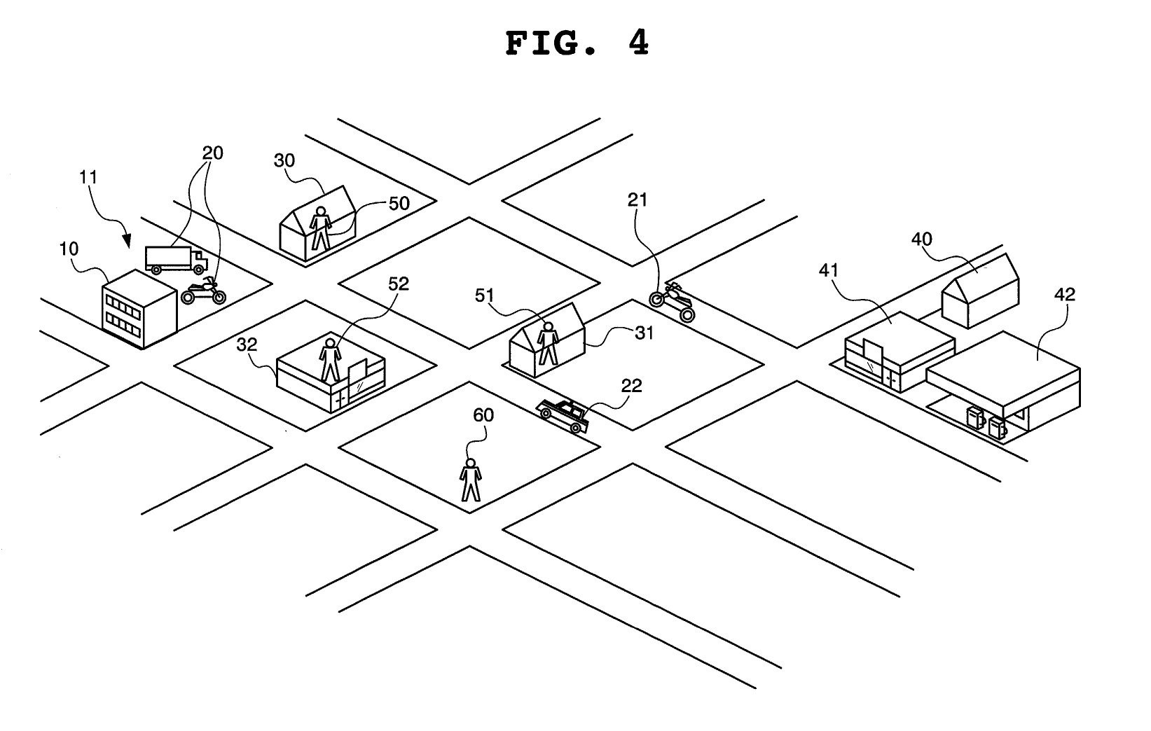

Next, with reference to FIGS. 3 and 4, a transportation method of the second embodiment will be described in detail. Since the present method differs from the transportation method of the first embodiment only in the third step shown in FIG. 8, description will be made only of the different third step.

[Third Step]

When a customer 52 wants an object to be transported to be directly transported from a business connection 32 (convenience store) to a delivery destination 41 (convenience store), the customer 52 inputs order information by filling by hand a transportation order form (not shown) prepared in a store with round-the-clock operation. Order information here includes, the address 32 of the business connection in charge of the object to be transported, an address of the delivery destination 41 of the object to be transported, a name of the object to be transported, the number of objects to be transported, a name of the customer 52, a telephone number of the customer 52, an electronic mail address of the customer 52, a name of a recipient, a telephone number of the recipient and the like.

Next, a clerk of the store with round-the-clock operation (business connection 32) receives the object to be transported and the transportation order form. Then, the clerk inputs the order information extracted from the transportation order form into the ordering terminal 2 (register). Then, when the clerk presses an order settlement button (not shown) displayed on a display means (not shown) of the ordering terminal 2, the ordering terminal 2 disposed in the store with round-the-clock operation transmits the order information to the order receiving server 3 through the line 5.

Assume that the input items, the address 32 of the business connection in charge of the object to be transported and the address of the delivery destination 41 of the object to be transported, are indispensable items to be input and that unless they are input, the order settlement button can not be clicked.

In addition, the item of the address 32 of the business connection in charge of the object to be transported may be filled in by a clerk in advance. Moreover, the address 32 of the business connection in charge of the object to be transported may be a code (convenience store code) indicative of a place of the store with round-the-clock operation. The order receiving server 3 needs to be provided with a table for converting the code into an address.

After the execution of the sixth step, a driver of a transportation vehicle 21 goes to the address 32 of the business connection in charge of the object to be transported to receive the object of the customer 52 from the clerk. Then, the driver of the transportation vehicle 21 goes to the address 41 of the delivery destination of the object to hand the object to be transported over to a clerk at the address 41 of the delivery destination of the object. At this time, the driver of the transportation vehicle 21 receives a certificate of the clerk's seal impression or his signature.

When order information and delivery information in the first embodiment each further include information about an electronic mail address of the customer 52, the transportation system, the transportation method, the mandatory terminal of a transportation vehicle, the ordering terminal and the order receiving server according to the second embodiment of the present invention further include, after the third step and before the sixth step, a step of receiving order information at the order receiving server 3 from the ordering terminal 2 through the line 5 to specify an electronic mail address of the customer 52 and a step of transmitting and receiving transportation completion information from/at a mandatory terminal of a transportation vehicle specified by the order receiving server 3 as a mandatory transportation vehicle to/from the terminal 4 of the customer 52 by means of an electronic mail through the line 5, as well as executing the eighth step of the first embodiment.

In other words, the second embodiment of the present invention has an advantage that a mandatory terminal of a mandated transportation vehicle is allowed to transmit transportation completion information to the customer's terminal 4, and the terminal 4 of the customer 52 responsively receives the transportation completion information to confirm that the mandated transportation vehicle (transportation vehicle) has completed transportation of an object to be transported (the customer's object to be transported arrives at the delivery destination 41 safely).

Moreover, in the second embodiment of the present invention, a location of a business connection in charge of a customer's object to be transported and/or a location of a delivery destination are in a store with round-the-clock operation. In other words, the ordering terminal 2 is disposed in a store with round-the-clock operation. The customer 52 is therefore allowed to deposit an object to be transported at the store with round-the-clock operation (the business connection 52 in charge of object to be transported). This produces an advantage that the customer 52 is not bound to time after depositing the object to be transported.

Furthermore, a transportation vehicle (mandated transportation vehicle) is allowed to leave an object to be transported with a store with round-the-clock operation (the delivery destination 41 in charge of the object to be transported). This produces an advantage that a transportation vehicle is not bound to time after depositing an object to be transported. In other words, a transportation vehicle is allowed to conduct transportation to transport a new object to be transported.

The present invention can be implemented also by the plurality of transportation vehicles of the second embodiment being transportation vehicles of a plurality of transportation companies.

According to the present embodiment, since the plurality of transportation vehicles are those of a plurality of transportation companies, the order receiving server 3 is allowed to transmit delivery information to a mandatory terminal of a transportation vehicle (mandated transportation vehicle) closest to a business connection in charge of a customer's object to be transported among transportation vehicles of the plurality of transportation companies allowed to conduct transportation.

More specifically, even when a customer 60 is at a place (unfamiliar place) different from an ordinary one, entering the store 52 with round-the-clock operation enables the customer to transmit order information to the order receiving server 3 through the ordering terminal 2 disposed in the store with round-the-clock operation. As a result, the ordering terminal 2 (order receiving server 3), in place of the customer 60 (52), will specify a transportation vehicle (mandatory transportation vehicle) closest to the business connection 32 in charge of the customer's object to be transported among the transportation vehicles of the plurality of transportation companies allowed to conduct transportation. In other words, the advantage is produced that the customer 60 (52) can specify a transportation vehicle closest to the business connection 32 in charge of the object to be transported through the ordering terminal 2 (order receiving server 3) with ease.

Store with round-the-clock operation is in other words a store provided with a means for allowing round-the-clock deposition of a customer's object to be transported.

The second embodiment is also characterized in that at least one of a plurality of transportation vehicles is a vehicle mainly for carrying a customer from a boarding place to an alighting place.

According to the present embodiment, the transportation vehicle may be a vehicle 22 (taxi) mainly for carrying a customer from a boarding place to an alighting place other than the transportation vehicles 20 and 21 for directly transporting an object to be transported from a business connection to a delivery destination.

A desired period of a transportation vehicle for directly transporting an object to be transported from a business connection to a delivery destination (period where the transportation vehicle is allowed to conduct transportation) is, for example, a period after the transportation vehicles 20 and 21 directly transport objects to be transported to a delivery destination until accepting a mandate for the transportation of a new object to be transported or other period.

On the other hand, a desired period of a transportation vehicle mainly for carrying a customer from a boarding place to an alighting place (period where the vehicle is allowed to conduct transportation) is, for example, a period after the vehicle 22 carries a customer to an alighting place (putting the customer down at the alighting place) until putting a new customer on board or other period.

As one example here, when the transportation vehicle 21 is allowed to conduct transportation for a long time, that is, after a lapse of a long time after the transportation vehicle 21 directly transports an object to be transported to the delivery destination 40, the transportation vehicle 21 will return to the lot 11 of the transportation company to wait. As a result, the transportation vehicles 20 and 21 allowed to conduct transportation will concentrate on the lot of the transportation company to reduce a probability that the transportation vehicle 21 allowed to conduct transportation will be near the business connection 31 in charge of the customer's object to be transported.

On the other hand, when the transportation vehicle mainly for carrying a customer from a boarding place to an alighting place is allowed to conduct transportation for a long time, that is, after a lapse of a long time after the vehicle 22 carries a customer to an alighting place, the vehicle 22 will run on the roads for carrying the new customer 60. As a result, the vehicle 22 allowed to conduct transportation will scatter to increase a probability that the vehicle 22 allowed to conduct transportation will be near the business connection 31 in charge of the customer's object to be transported. This produces an advantage that the transportation vehicle (vehicle mainly for carrying a customer from a boarding place to an alighting place) 22 can transport objects reliably and quickly according to a request from a customer.

The vehicle 22 mainly for carrying a customer from a boarding place to an alighting place is, for example, a taxi. As well as mainly carrying customers from a boarding place to an alighting place, taxi can transport objects in a desired period.

Consideration will be further given to a case where a vehicle mainly for carrying a customer from a boarding place to an alighting place has round-the-clock operation.

Since few customers 60 are on the roads late at night, the vehicle 22 having round-the-clock operation will further run on the roads. In other word, since the vehicle 22 mainly for carrying a customer from a boarding place to an alighting place is allowed to conduct transportation for a long period, the probability will be further increased that the vehicle 22 allowed to conduct transportation will be near the business connection 52 in charge of the customer's object to be transported. This produces an advantage that a transportation vehicle (vehicle 22 mainly for carrying a customer from a boarding place to an alighting place) can transport objects more reliably and quickly according to a customer's request.

Late at night denotes a time from 10 p.m. to 5 a.m. or a time from 11 p.m. to 6 a.m.

As described in the foregoing, according to the present invention, delivery information is transmitted to a mandatory terminal of a transportation vehicle (mandated transportation vehicle) closest to a business connection in charge of a customer's object to be transported among a plurality of transportation vehicles allowed to conduct transportation. Responsively, the mandated transportation vehicle does not always go to the business connection in charge of the object to be transported from a position where it is mandated for transportation of the object to be transported (in a lot of a transportation company) while waiting in the lot of the transportation company but is allowed to go to the business connection in charge of the object to be transported from a position where it is mandated for transportation of the object to be transported (current position of the transportation vehicle closest to the business connection in charge of the object to be transported) in a desired period (period where the transportation vehicle is allowed to conduct transportation).

This enables reduction in a time for the transportation vehicle to go to the business connection in charge of the object to be transported from a position where it is mandated for transportation of the object to be transported (current position of the transportation vehicle closest to the business connection in charge of the object to be transported), thereby producing an effect of quick transportation by a transportation vehicle (mandated transportation vehicle) according to a customer's request.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A transportation system comprising:
mandatory terminals of a plurality of transportation vehicles which directly transport an object to be transported from a business connection to a delivery destination for periodically transmitting current location information of their own to an order receiving server through a line to receive delivery information including a location of a business connection in charge of an object to be transported and a location of a delivery destination from said order receiving server through said line,
a plurality of ordering terminals for placing an order for transportation of an object to be transported which transmit order information including a location of a business connection in charge of said object to be transported and a location of a delivery destination to the order receiving server through said line, and
an order receiving order for receiving an order for transportation of said object to be transported which transmits, for each said order information, said delivery information to specific said transportation vehicle closest to a location of a business connection in charge of said object to be transported among said transportation vehicles.

2. The transportation system as set forth in claim 1, wherein
said mandatory terminal of the transportation vehicle includes:
transmission means for periodically transmitting current location information of its own to the order receiving server through the line, and
means for receiving delivery information including a location of a business connection in charge of said object to be transported and a location of a delivery destination from said order receiving server through said line, and
said order receiving server includes:
means for receiving said current location information of one's own from each said mandatory terminal of said plurality of transportation vehicles through said line to specify each current location information of said plurality of transportation vehicles,
means for receiving said order information from each of said plurality of ordering terminals through said line to specify each location of a business connection in charge of said object to be transported and each location of a delivery destination,
means for specifying a transportation vehicle having the current location information of a transportation vehicle closest to each location of a business connection in charge of said object to be transported among respective current location information of said plurality of transportation vehicles as a mandated transportation vehicle, and
means for transmitting said delivery information to each mandatory terminal of the transportation vehicle specified as said mandated transportation vehicle through said line.

3. The transportation system as set forth in claim 2, wherein
said mandatory terminal of the transportation vehicle further includes
control means for enabling said transmission means to transmit said current location information of one's own only in a desired period.

4. The transportation system as set forth in claim 2, wherein
each of said plurality of ordering terminals includes
means for transmitting, to said order receiving server through said line, transportation start information to the effect that a transportation vehicle specified by said order receiving server as said mandatory transportation vehicle will transport said object to be transported from the business connection, and
said order receiving server includes means for receiving said transportation start information through said line.

5. The transportation system as set forth in claim 2, wherein
each mandatory terminal of said plurality of transportation vehicles includes
means for transmitting transportation completion information to the effect that the object to be transported of said customer is transported to the delivery destination to said order receiving server through said line, and
said order receiving server includes means for receiving said transportation completion information through said line.

6. The transportation system as set forth in claim 2, wherein
each of said plurality of ordering terminals includes:
means for transmitting, to said order receiving server through said line, transportation start information to the effect that a transportation vehicle specified by said order receiving server as said mandatory transportation vehicle will transport said object to be transported from a business connection, and
means for transmitting transportation completion information to the effect that said object to be transported is transported to the delivery destination to said order receiving server through said line, and
said order receiving server includes:
means for receiving said transportation start information through said line, and
means for receiving said transportation completion information through said line.

7. The transportation system as set forth in claim 2, wherein
each mandatory terminal of said plurality of transportation vehicles includes
means for transmitting transportation completion information to the effect that said object to be transported is transported to the delivery destination to said order receiving server through said line,
said order receiving server includes means for receiving said transportation completion information through said line,
each of said order information and said delivery information further includes an electronic mail address of said customer,
said order receiving server includes means for receiving said order information from each of said plurality of ordering terminals through said line to specify an electronic mail address of said customer, and
each mandatory terminal of said plurality of transportation vehicles includes means for transmitting said transportation completion information to said order receiving server through said line, as well as transmitting said transportation completion information to a terminal of said customer by means of an electronic mail through said line.

8. The transportation system as set forth in claim 2, wherein
each of said plurality of ordering terminals includes:
means for transmitting, to said order receiving server through said line, transportation start information to the effect that a transportation vehicle specified by said order receiving server as said mandatory transportation vehicle will transport said object to be transported of said customer from the business connection, and
means for transmitting transportation completion information to the effect that said object to be transported is transported to the delivery destination to said order receiving server through said line,
said order receiving server includes:
means for receiving said transportation start information through said line, and
means for receiving said transportation completion information through said line,
each of said order information and said delivery information further includes an electronic mail address of said customer,
said order receiving server further includes means for receiving said order information from each of said plurality of ordering terminals through said line to specify an electronic mail address of said customer, and
each mandatory terminal of said plurality of transportation vehicles includes means for transmitting said transportation completion information to said order receiving server through said line, as well as transmitting said transportation completion information to a terminal of said customer by means of an electronic mail through said line.

9. The transportation system as set forth in claim 1, wherein
said plurality of transportation vehicles are transportation vehicles of a plurality of transportation companies.

10. The transportation system as set forth in claim 1, wherein
at least one of said plurality of transportation vehicles is a vehicle mainly for carrying a customer from a boarding place to an alighting place.

11. The transportation system as set forth in claim 1, wherein
a location of a business connection in charge of an object to be transported of said customer and/or a location of a delivery destination are in a store with round-the-clock operation.

12. A mandatory terminal of a transportation vehicle for directly transporting an object to be transported from a business connection to a delivery destination, comprising:
transmission means for periodically transmitting current location information of its own to an order receiving server through a line,
control means for enabling said transmission means to transmit said current location information of its own only in a desired period, and
means for receiving delivery information including a location of a business connection in charge of an object to be transported and a location of a delivery destination from said order receiving server through said line.

13. The mandatory terminal of a transportation vehicle as set forth in claim 12, further comprising
means for transmitting, to said order receiving server through said line, transportation start information to the effect that a transportation vehicle specified by said order receiving server as said mandatory transportation vehicle will transport said object to be transported from the business connection.

14. The mandatory terminal of a transportation vehicle as set forth in claim 12, further comprising
means for transmitting transportation completion information to the effect that the object to be transported of said customer is transported to the delivery destination to said order receiving server through said line.

15. The mandatory terminal of a transportation vehicle as set forth in claim 12, further comprising:
means for transmitting, to said order receiving server through said line, transportation start information to the effect that a transportation vehicle specified by said order receiving server as said mandatory transportation vehicle will transport said object to be transported from the business connection, and
means for transmitting transportation completion information to the effect that said object to be transported is transported to the delivery destination to said order receiving server through said line.

16. An order receiving server for receiving an order for transportation of an object to be transported, comprising:
means for receiving current location information of one's own from each mandatory terminal of a plurality of transportation vehicles through the line to specify each current location information of said plurality of transportation vehicles,
means for receiving order information including a location of a business connection in charge of a customer's object to be transported and a location of a delivery destination from a plurality of ordering terminals through said line to specify a location of the business connection in charge of the object to be transported of said customer and a location of the delivery destination,
means for specifying each transportation vehicle having current location information of a transportation vehicle closest to a location of the business connection in charge of the object to be transported of said customer among current location information of said plurality of transportation vehicles as a mandatory transportation vehicle, and
means for transmitting delivery information including a location of the business connection in charge of the object to be transported of said customer and a location of the delivery destination to each mandatory terminal of the transportation vehicle specified as said mandatory transportation vehicle through said line.

17. The order receiving server for receiving an order for transportation of an object to be transported as set forth in claim 16, further comprising
means for receiving, through said line, said transportation start information sent from a transportation vehicle specified as said mandatory transportation vehicle to the effect that the transportation vehicle will transport the object to be transported from the business connection.

18. The order receiving server for receiving an order for transportation of an object to be transported as set forth in claim 16, further comprising
means for receiving, through said line, transportation completion information sent from a transportation vehicle specified as said mandatory transportation vehicle to the effect that the object to be transported is transported to the delivery destination.

19. The order receiving server for receiving an order for transportation of an object to be transported as set forth in claim 16, further comprising:
means for receiving, through said line, said transportation start information sent from a transportation vehicle specified as said mandatory transportation vehicle to the effect that the transportation vehicle will transport the object to be transported from the business connection, and
means for receiving, through said line, transportation completion information sent from a transportation vehicle specified as said mandatory transportation vehicle to the effect that the object to be transported is transported to the delivery destination.

20. A transportation method using a communication line, comprising the steps of:
a first step of periodically transmitting each current location information of one's own from each mandatory terminal of a plurality of transportation vehicles for directly transporting an object to be transported from a business connection to a delivery destination to an order receiving server through a line only in a desired period,
a second step of receiving said current location information of one's own at said order receiving server from each mandatory terminal of said plurality of transportation vehicles through said line to specify each current location information of said plurality of transportation vehicles,
a third step of transmitting order information including a location of a business connection in charge of a customer's object to be transported and a location of a delivery destination from an ordering terminal for placing an order for transportation of a customer's object to be transported to said order receiving server through said line,
a fourth step of receiving the order information including a location of a business connection in charge of an object to be transported of said customer and a location of a delivery destination at said order receiving server from said ordering terminal through said line to specify a location of the business connection in charge of the object to be transported of said customer and a location of the delivery destination,
a fifth step of specifying a transportation vehicle having current location information of a transportation vehicle closest to the location of the business connection in charge of the object to be transported of said customer among current location information of said plurality of transportation vehicles as a mandatory transportation vehicle, and
a sixth step of transmitting and receiving delivery information including a location of a business connection in charge of a customer's object to be transported and a location of a delivery destination from/at said order receiving sever to/from the mandatory terminal of a transportation vehicle specified as said mandatory transportation vehicle through said line.

21. The transportation method using a communication line as set forth in claim 20, further comprising:
after said sixth step, a seventh step of transmitting and receiving transportation start information to the effect that the transportation vehicle specified by said order receiving server as said mandatory transportation vehicle will transport the object to be transported of said customer from the business connection from/at said ordering terminal to/from said order receiving server through said line.

22. The transportation method using a communication line as set forth in claim 20, further comprising:
after said sixth step, an eighth step of transmitting and receiving transportation completion information to the effect that the object to be transported of said customer is transported to the delivery destination from/at the mandatory terminal of the transportation vehicle specified by said order receiving server as said mandatory transportation vehicle to/from said order receiving server through said line.

23. The transportation method using a communication line as set forth in claim 20, further comprising:
after said sixth step, a seventh step of transmitting and receiving transportation start information to the effect that the transportation vehicle specified by said order receiving server as said mandatory transportation vehicle will transport the object to be transported of said customer from the business connection from/at the ordering terminal to/from said order receiving server through said line, and
after said sixth step, an eighth step of transmitting and receiving transportation completion information to the effect that the object to be transported of said customer is transported to the delivery destination from/at the mandatory terminal of the transportation vehicle specified by said order receiving server as said mandatory transportation vehicle to/from said order receiving server through said line.

24. The transportation method using a communication line as set forth in claim 20, further comprising:
after said sixth step, an eighth step of transmitting and receiving transportation completion information to the effect that the object to be transported of said customer is transported to the delivery destination from/at the mandatory terminal of the transportation vehicle specified by said order receiving server as said mandatory transportation vehicle to/from said order receiving server through said line, wherein
each of said order information and said delivery information further includes information of an electronic mail address of said customer, and which further comprises:
after said third step and before said sixth step, a step of receiving said order information at said order receiving server from said ordering terminal through said line to specify an electronic mail address of said customer, and
a step of transmitting and receiving said transportation completion information from/at the mandatory terminal of the transportation vehicle specified by said order receiving server as said mandatory transportation vehicle to/from a terminal of said customer by an electronic mail through said line, as well as executing said eighth step.

25. The transportation method using a communication line as set forth in claim 20, further comprising:
after said sixth step, a seventh step of transmitting and receiving transportation start information to the effect that the transportation vehicle specified by said order receiving server as said mandatory transportation vehicle will transport the object to be transported of said customer from the business connection from/at said ordering terminal to/from said order receiving server through said line,
after said sixth step, an eighth step of transmitting and receiving transportation completion information to the effect that the object to be transported of said customer is transported to the delivery destination from/at the mandatory terminal of the transportation vehicle specified by said order receiving server as said mandatory transportation vehicle to/from said order receiving server through said line, wherein
each of said order information and said delivery information further includes information of an electronic mail address of said customer, and which further comprises:
after said third step and before said sixth step, a step of receiving said order information at said order receiving server from said ordering terminal through said line to specify an electronic mail address of said customer, and
a step of transmitting and receiving said transportation completion information from/at the mandatory terminal of the transportation vehicle specified by said order receiving server as said mandatory transportation vehicle to/from a terminal of said customer by an electronic mail through said line, as well as executing said eighth step.

26. The transportation method using a communication line as set forth in claim 20, wherein
said plurality of transportation vehicles are transportation vehicles of a plurality of transportation companies.

27. The transportation method using a communication line as set forth in claim 20, wherein
at least one of said plurality of transportation vehicles is a vehicle mainly for carrying a customer from a boarding place to an alighting place.

28. The transportation method using a communication line as set forth in claim 20, wherein
a location of a business connection in charge of an object to be transport e d of said customer and/or a location of a delivery destination are in a store with round-the-clock operation.
